(19) United States
(12) Patent Application Publication
(10) Pub. No.: US 2022/0084074 A1
(43) Pub. Date: Mar. 17, 2022

(54) Privacy Preserving Ad Personalization

(71) Applicant: Button, Inc., Greenwich, CT (US)

(72) Inventors: Christopher James Maddern, New York, NY (US); Sean Joey Summers, San Francisco, CA (US)

(73) Assignee: Button, Inc., Greenwich, CT (US)

(21) Appl. No.: 17/474,667

(22) Filed: Sep. 14, 2021

Related U.S. Application Data
(60) Provisional application No. 63/078,022, filed on Sep. 14, 2020.

(51) Int. Cl. G06Q 30/02

(52) U.S. Cl. CPC G06Q 30/0271; G06Q 30/0243

(57) ABSTRACT

The technology is drawn to targeting advertisements and offers to consumers while maintaining the consumer's anonymity. One or more processors may receive a set of campaigns, each campaign in the set of campaigns including an eligibility set defined by a set of consumer identifiers. The eligibility set of each campaign may be converted into a privacy preserving model that maps the set of consumer identifiers to any number of advertisements or offers in the set of campaigns. The one or more processors may provide the privacy preserving model to a publisher.

### CROSS-REFERENCE TO RELATED APPLICATION

This application claims the benefit of the filing date of United States Provisional Patent Application No. 63/078,022 filed on Sep. 14, 2020, the disclosure of which is hereby incorporated herein by reference.

### BACKGROUND

The modern marketing stack relies on private consumer information collected from third party data sources to provide accurate targeting and measurement of ads and offers across applications and websites. Private consumer information may be collected by third party data sources which provide or sell the private consumer information to business for use in marketing campaigns. Additionally, businesses may collect private consumer information directly during interactions with consumers, such as when users visit the businesses store or websites.

Increased consumer privacy concerns threaten to diminish the capabilities of the modern marketing stack by limiting the collection and use of private consumer information. For instance, regulations such as General Data Protection Regulation (GDPR), and the California Consumer Privacy Act (CCPA) regulate the ability of businesses to collect, utilize, and share private consumer information. Similarly, many technology companies have begun limiting the ability to collect, share, and use private consumer information within their ecosystems and applications by enforcing privacy guidelines and terms of service agreements.

### SUMMARY

This present disclosure is directed to targeting advertisements and offers to consumers while maintaining the anonymity of the consumer. One aspect of the disclosure is directed to a method for targeting advertisements and offers to consumers. The method comprising: receiving, by one or more processors, a set of campaigns, each campaign in the set of campaigns including an eligibility set defined by a set of consumer identifiers; converting, by the one or more processors, the eligibility set of each campaign into a privacy preserving model that maps the set of consumer identifiers to any number of advertisements or offers in the set of campaigns; and providing, by the one or more processors, the privacy preserving model to a publisher.

Another aspect of the disclosure is directed to a system, the system comprising one or more processors; and memory storing instructions. The instructions, when executed by the one or more processors, cause the one or more processors to: receive a set of campaigns, each campaign in the set of campaigns including an eligibility set defined by a set of consumer identifiers; convert the eligibility set of each campaign into a privacy preserving model that maps the set of consumer identifiers to any number of advertisements or offers in the set of campaigns; provide the privacy preserving model to a publisher.

Another aspect of the disclosure is directed to a non-transitory computer-readable medium storing instructions, the instructions, when executed by one or more processors, causing the one or more processors to: receive a set of campaigns, each campaign in the set of campaigns including an eligibility set defined by a set of consumer identifiers; convert the eligibility set of each campaign into a privacy preserving model that maps the set of consumer identifiers to any number of advertisements or offers in the set of campaigns; and provide the privacy preserving model to a publisher.

In some embodiments, each campaign in the set of campaigns includes at least one advertisement or offer.

In some embodiments, the converting eligibility set further includes mapping the set of consumer identifiers to an eligibility sequence representing each consumers to each of the campaigns in the set of campaigns.

In some aspects, the eligibility sequence includes a listing of numerical, alphabetical, or alphanumerical values, wherein each value indicates a respective consumers eligibility for a particular campaign in the set of campaigns.

In some embodiments, prior to converting the eligibility set of each campaign into a privacy preserving model, adding noise into the eligibility set of each campaign.

In some embodiments, prior to converting the eligibility set of each campaign into a privacy preserving model, adding noise into the eligibility set of each campaign, wherein the noise added to each of the eligibility sets is the same.

In some embodiments, mapping the set of consumer identifiers to any number of advertisements or offers in the set of campaigns includes processing the set of consumer identifiers through one or more Bloom filters and/or Bloomer filters.

### BRIEF DESCRIPTION OF THE DRAWINGS

FIG. 1 is an example distributed computing system in accordance with embodiments of the disclosure.

FIG. 2 is an example pre-display eligibility setup flow diagram in accordance with embodiments of the disclosure.

FIG. 3 is an example ad display flow diagram in accordance with embodiments of the disclosure.

FIG. 4 is another example pre-display eligibility setup flow diagram in accordance with embodiments of the disclosure.

FIG. 5 is flow diagram representing the creation of a campaign in accordance with aspects of the disclosure.

FIG. 6 is a flow diagram outlining model generation in accordance with aspects of the disclosure.

FIG. 7 is another flow diagram outlining model generation in accordance with aspects of the disclosure.

FIG. 8 is a flow diagram outlining sub-model generation in accordance with aspects of the disclosure.

### DETAILED DESCRIPTION

### Overview

This technology is directed to methods and systems for providing targeted advertisements and offers to consumers (including customers and/or potential customers) at least as efficiently and performant as existing marketing methodologies while maintaining the privacy of consumers. For example, Advertisers may provide Publishers with advertisement or offer campaigns targeted to particular consumers through a Service, while maintaining the privacy of consumers known by the Advertisers and Publishers. In this regard, consumer personal information, such as consumer identifiers discussed herein, is never shared between Advertisers and Publishers. Moreover, consumer personal information known by Publishers is never transferred or otherwise shared with the Service or Advertisers.

As used herein, an Advertiser is a party, such as a business or marketing agency, which creates advertisement or offer campaigns, collectively referred to herein as “campaigns”. A Publisher is a party that publishes an advertisement or offer from a campaign to a consumer. For instance, the Publisher may be a company that operates a mobile application, applications, websites, etc., which provide advertisements or offers. A Publisher may also include companies that integrate or provide software that is integrated into mobile applications, websites, etc., for providing advertisements or offers to users of the mobile applications, applications, websites, etc. As further detailed herein, a Service is an intermediary between the Advertiser and Publisher.

To provide targeted advertisements or offers, an Advertiser may create advertisement or offer campaigns and restrict each advertisement or offer campaign to an eligibility set defined by consumer identifiers, such as device id's, email addresses, etc. The Advertiser may provide the advertisement or offer campaigns to the Service along with the eligibility set for each campaign. The eligibility set may be considered targeting data that defines the target audience (e.g., consumers) for particular campaigns.

The Service may transform the eligibility sets into privacy preserving models that map a collection of consumer identifiers to any number of eligible advertisement or offer campaigns. In some instances, the transformation of the eligibility sets into models may be performed before being uploaded by the Advertiser to the Service to ensure that consumer identifiers known by the Advertiser is not learned or stored by the Service. The Service may provide the software required to transform the eligibility sets into models to the Advertiser.

A Publisher, using software supplied by the Service, may request the most up-to-date model from the Service. In this regard, the Publisher, through a user device or through a system operated by the publisher may request a model from the Service for use in determining what advertisement or offer campaigns a consumer utilizing the Publisher's applications or some other entity operated by the Publisher, such as a website, should be shown. In some instances, the Publisher may request privacy preserving sub-models. The privacy preserving sub-models may be Publisher specific to reduce, and even eliminate, the possibility that requests for sub-models can be used as a consumer fingerprint across applications and websites operated by other Publishers.

The Publisher may evaluate privately stored consumer information associated with the consumer against the model or sub-models received from the Service. In this regard, for the consumer information associated with the consumer, the model or sub-models may return an eligibility sequence (e.g., 0's and 1's) that is non-unique to the consumer and privacy preserving.

The eligibility sequence may be used to determine which advertisements and offer campaigns the consumer is eligible to receive. In this regard, the Publisher may send the eligibility sequence to the Service and the Service may map the eligibility sequence to advertisement and offer campaigns and forward these advertisement and offer campaigns to the Publisher in a list for display to the consumer. Alternatively, for a complete on-device evaluation, a Publisher can request a complete and up-to-date campaign model from the Service which returns the advertisement and offer campaign list that is stored on-device. The device can then select a campaign by interpreting the provided mapping of eligibility sequence to campaigns defined in the advertisement and offer campaign list, using software provided by the Service. In this case the eligibility sequence is never sent to the Service.

The above systems and methods, and those described herein, maintain consumer privacy by satisfying the set of guidelines including:

Private consumer identifier(s) uploaded by an Advertiser that maps eligible consumers to a specific advertisement or offer may not be shared in an identifiable form with the Publisher who serves the ad;

Private consumer identifier(s) belonging to a Publisher are never transferred or learned by the Service or Advertiser. The private consumer identifier(s) are maintained privately and locally by the Publisher (e.g. either on a mobile device or “on premises” by the Publisher);

Consumers interacting with a Publisher application and/or website are shown personalized advertisements or offers according to the specifications of each Advertisers' campaign; and

Consumers who are shown and/or interact with personalized advertisements or offers cannot be identified across Publisher and Advertiser applications and websites.

By following the guidelines outlined above, the above systems and methods, and those described herein, maintain consumer privacy, while simultaneously providing targeted advertisements and offers to consumers.

As used herein, the terms “advertisements” and “offers” may be used interchangeably. In this regard, and unless otherwise specified, any discussion of an “offer” or “offers” may be applicable to an “advertisement” or “advertisements,” respectively.

### Example Systems

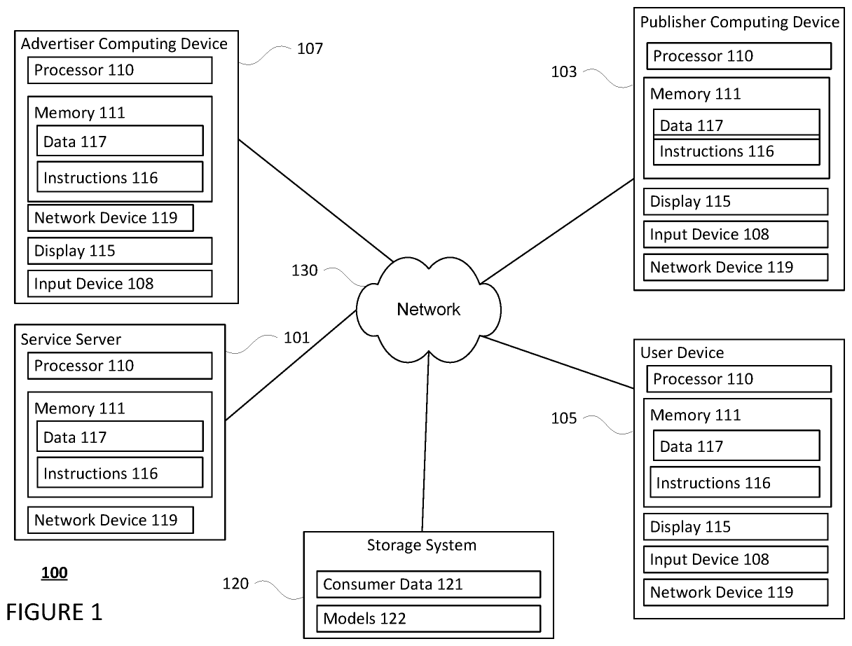

FIG. 1 shows an example distributed computing system 100 in which the features described herein may be implemented. In this example, system 100 includes service server 101, publisher computing device 103, user device 105, and advertiser computing device 107 which may each be referred to as computing devices. The distributed computing system 100 may also include one or more storage devices, such as storage system 120. Communication between the computing devices 101-107, as well as between the computing devices 101-107 and storage device 120 and other devices, may be performed via network devices 119 through network 130, as described herein. Although not shown, communication between components of each computing device may be made through one or more communication buses. For instance, the processor 110, memory 111, and network device 119 of publisher computing device 103 may communicate via one or more communication buses.

FIG. 1 should not be considered as limiting the scope of the disclosure or usefulness of the features described herein. In this regard, the features described herein may be implemented with many types of general or special purpose computing devices, such as personal computers, laptops, tablets, mobile phones, virtual computers, etc. Further, the features described herein may be implemented using many different combinations of devices. Moreover, although only computing devices 101-107 are depicted in FIG. 1, it should be appreciated that a typical system can include a large number of connected computing devices, such as more than one service server, publisher computing device, advertiser computing device and/or user device.

Each computing device 101-105 may contain one or more processors 110, one or more memory 111, and/or other components commonly found in general and special purpose computing devices. For example, service server 101 includes one or more processors 110, memory 111, and network interface 119. Other service servers (not shown) may include some or all of the components shown in service server 101.

The one or more processors 110 can be any conventional processors, such as commercially available CPUs from Intel®, AMD®, or Apple®. Alternatively, or in addition to the commercially available CPUs, the processors can be dedicated components such as an application specific integrated circuit (“ASIC”) or other hardware-based processors, such as an ARM processor, field programmable gate array (FPGA), or System on Chip (SoC).

Memory 111 may store information that can be retrieved, executed, and/or manipulated by the processors 110, such as instructions 116 and data 117. The memory 111 may be any type of non-transitory computer readable media that is readable and/or writable by the computing devices 101-105. For instance, computer readable media may include volatile and/or nonvolatile disk based hard drives, solid state hard drives, hybrid hard drives, memory cards, flash read-only memory (ROM), random access memory (RAM), NAND memory, DVDs, CD-ROMs, EEPROM, and other magnetic or optical storage. The memory 111 can include any combination of non-transitory computer readable media, such as a hard drive and RAM, etc.

The instructions 116 may be stored in any format which may be read and executed by the processor. In this regard, the instructions may include any executable code, such as machine code, scripts, applications, etc. Applications may include, for instance, an operating system (OS), a web browser, web browser extensions, mobile applications, such as mobile applications published by Publishers, computer applications, etc. In some instances, instructions 116 may include portions of executable code, such as application modules which are part of a larger application, or entire applications, such as one or more of applications 113. The instructions 116 may include models, rules, etc., that may be used in providing the features described herein. A model may include a model generated by a Service or Advertiser, as described herein. Rules may be used in place of or in conjunction with models. For example, rules may be configured to determine how to utilize a model. Moreover, the rules may define which databases or other such sources of information may be accessed to determine and gather necessary data. The rules may be static such that they are not altered absent being reprogrammed. In some instances the rules may be dynamic such that they may be automatically adjusted or adjusted periodically.

Data 117 may be retrieved, stored, or modified by the one or more processors 110 based on instructions 116. For example, although the system and methods described herein is not limited by any particular data structure, the data 117 can be stored in registers, databases, such as relational databases, tables, or XML documents. The data 117 is not limited to any particular data structure or format. For instance, the data 117 can include individual pieces or data as well as larger data structures such as relational databases, tables, XML documents, etc. Additionally, the data may be formatted in many formats such as, but not limited to, binary values, ASCII or Unicode. Moreover, the data 118 can include any information sufficient to identify and/or differentiate relevant information, such as numbers, descriptive text, proprietary codes, pointers, references to data stored in other memories, such as at other network locations, or information that is used by a function to calculate the relevant data. The data 117 may include consumer data and other such data that may be used in providing the features described herein. Consumer data may include, by way of non-limiting examples, consumer identifiers such as consumer email addresses, phone numbers, device identifiers (ids), names, addresses, etc.

Each Publisher may maintain consumer identifiers within memory 111. In this regard, for each consumer that is a member of, utilizes, and/or otherwise is associated with a Publisher, the Publisher may maintain a mutable, growing and/or retractable list of private consumer identifiers representative of that consumer.

Storage system 120 can include any type of storage capable of storing information accessible by the service server 101, publisher computing device 103, advertiser computing device 107, and/or user device 105. As shown in FIG. 1, storage system 120 may store consumer data 121, models 122, etc. Storage system 120 may also store any of the other data or instructions described herein.

Storage device 120 may include a distributed storage system where data is stored on a plurality of different storage devices which may be physically located at the same or different geographic locations, such as network attached storage or distributed data warehouses. Storage device 150 may be connected to the computing devices via the network 130 as shown in FIG. 1, and/or may be directly connected to any of the computing devices 101-107. Although only a single storage system 120 is shown in FIG. 1, any number of storage systems may be included in the example distributed computing system 100. In some instances, access to storage system 120 may be limited to particular computing devices. By way of a non-limiting example, storage system 120 may be configured to communicate with user device 105 and service server 101, but not publisher computing device 103. In some instances, a storage system may be provided for each computing device or groups of computing devices.

Each of the computing devices 101-105 can be at different locations of a network 130 and capable of directly and indirectly communicating with other components at different locations on the network 130. Although only computing devices 101-105 are depicted in FIG. 1, it should be appreciated that a typical system can include a large number of connected computing devices, with the different computing devices being at the same and/or different locations on the network 130. The network 130 described herein can be interconnected using various protocols and systems, such that the network can be part of the Internet, World Wide Web, specific intranets, wide area networks, or local networks. The network can utilize standard communications protocols and technologies, such as by way of non-limiting examples, Ethernet, Wi-Fi, HTTP, 3G, 4G, 5G, Bluetooth, and UDP protocols that are proprietary to one or more companies, and various combinations of the foregoing. Although certain advantages may be obtained when information is transmitted or received as noted above, other aspects of the subject matter described herein are not limited to any particular manner of transmission of information.

The computing device 101-105 may each have a network device 119 for enabling communication with other computing devices or networked systems. For instance, network device 119 may include a network interface card (NIC), Wi-Fi card, Bluetooth receiver/transmitter, or other such device capable of communicating data over a network via one or more communication protocols and technologies. As an example, service server 101 may be a web server capable of communicating with storage system 120 as well as computing devices 103 and 105 through the network 130 via network devices 119. The web server of service server 101 may use network 130 to transmit and present information to a user, such as on a display 115 of user device 105.

Each of the computing devices 103, 105, and 107 may be configured similarly to the service servers 101, with one or more processors, memory, and storage mediums as described above. Computing devices 103-107 may be a personal computing device intended for use by a user, and have all of the components normally used in connection with a personal computing device such as a central processing unit (CPU), memory (e.g., RAM and internal hard drives) storing data and instructions, a display such as display 115, (e.g., a monitor having a screen, a touch-screen, a projector, a television, or other device that is operable to display information), and input device 108 (e.g., a mouse, keyboard, touch-screen, or microphone). Although not shown, service server 101 may also include displays and user input devices.

Although the computing devices 103, 105, and 107 may each comprise a full-sized personal computing device, they may alternatively comprise mobile computing devices capable of wirelessly exchanging data with a server, such as service server 101 over a network such as the Internet. By way of example only, user device 105 may be a mobile phone or a device such as a wireless-enabled PDA, a tablet PC, or a netbook. In another example, user device 105 may be a laptop computer.

Although FIG. 1 illustrates the processor 110, memory 111, storage medium 112, and other elements of computing devices 101-107 as being within the same device, the processor 110, memory 111, storage medium 112, and other elements of computing devices 101-105 may be stored in different locations or housings. For example, and referring to service server 101, the processor 110, and memory 111 may be located in a different housing from storage medium 112. Accordingly, references to a processor, computer, computing device, memory, or storage medium will be understood to include references to a collection of processors, computers, computing devices, memories, or storage mediums that may or may not operate in parallel. For example, the service server 101 may include server computing devices. The service server 101 may be configured to operate as a load-balanced server farm, distributed system, etc. Similarly, publisher computing device may be configured as a server. Yet further, although some functions described below are indicated as taking place on a single computing device having a single processor, various aspects of the subject matter described herein can be implemented by a plurality of computing devices that, for example, communicate information over network 130.

### Example Methods

In addition to the operations and systems described above and illustrated in the figures, various operations will now be described. The following operations do not have to be performed in the precise order described below. Rather, various steps can be handled in a different order or simultaneously, and steps may also be added or omitted.

### General Operation

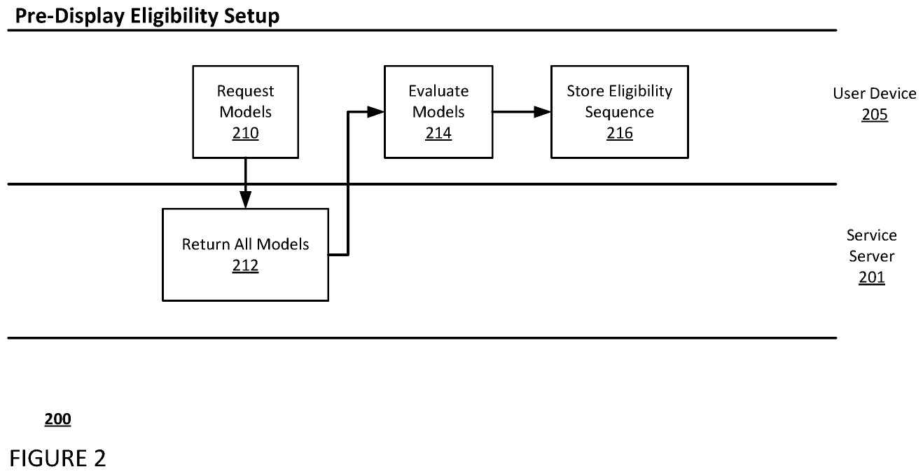

FIG. 2 illustrates a flow diagram 200 outlining the general operation of a system for providing models to generate an eligibility sequence for a consumer. As shown in FIG. 2, the components of the system may include a user device 205, which may be similar to user device 105, and a service server 201, which may be similar to service server 101. Although not shown, the user device 205 may execute a mobile application or website provided by a Publisher or which is otherwise integrated with software provided by the Publisher. In this regard, the Publisher's application, website, or software may control the operation of the user device 205 during the steps outlined in FIG. 2.

As further shown in FIG. 2, the user device 205 may request models from the service server 201, as shown in block 210. In response to the request, the service server 205 may return all models to the user device 205. The user device 205 may then evaluate the models using consumer identifiers associated with the consumer for which an advertisement or offer is being requested, as shown in block 214. The evaluation of the model may include generating an eligibility sequence for the consumer, which may be stored in the user device 205, as shown in block 216.

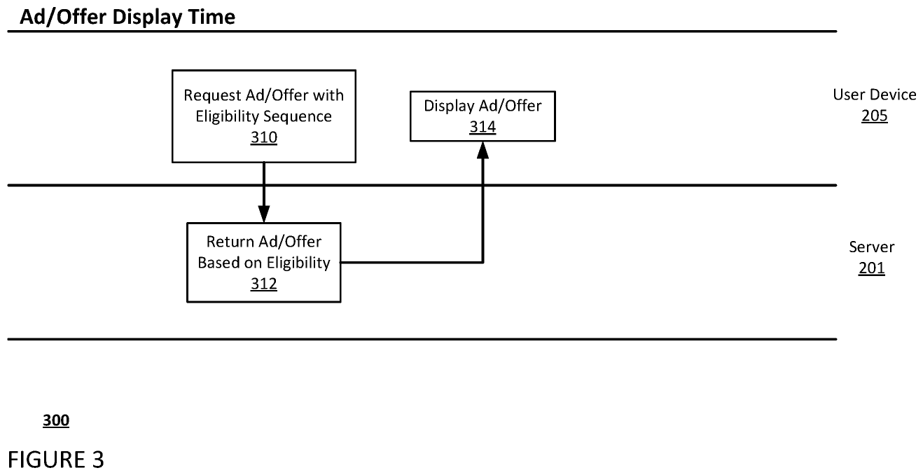

FIG. 3 illustrates another flow diagram 300 outlining the general operation of providing an advertisement or offer to a user device. In this regard, the user device 205 may transmit the eligibility sequence for the consumer along with a request for an advertisement (ad) or offer to the service server 201, as shown in block 310. In response to the request, the service server may return one or more offers or advertisements to the user device 205, as shown in block 312. The one or more offers or advertisements provided to the user device 205 may be determined based on the eligibility of the consumer to view offers or advertisements as determined from the eligibility sequence and the models. The user device 205 may then display one or more of the returned advertisements or offers to the consumer, as shown in block 314.

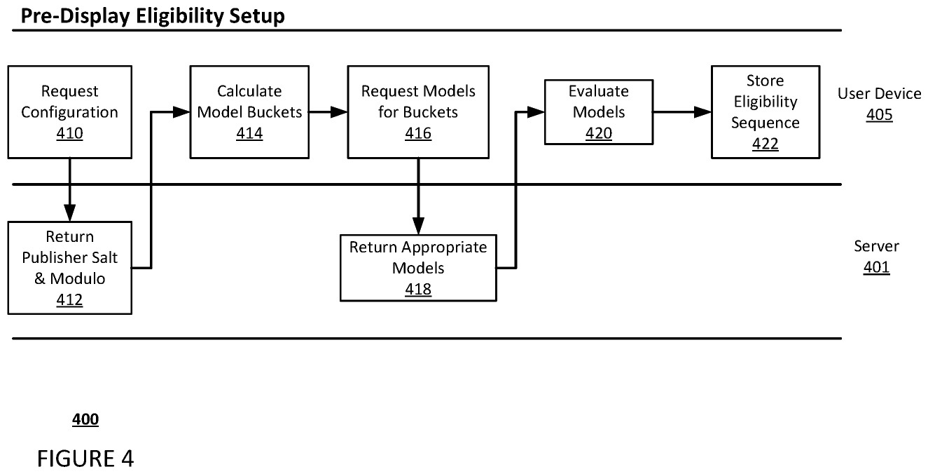

The above operation outlined with reference to FIGS. 3 and 4 provide targeted advertisements and offers to consumers without any sharing of PI of the consumer by the Publisher. Moreover, no raw targeting data from the Advertiser is shared with the Publisher (or user device). However, since all models are provided from the service server 201 to the user device 205, the amount of data transmitted between the service server and user device may be large, as each individual model can be 100 mb or more. Moreover, the amount of processing by the user device 205 to evaluate all of the models may be high, which may lead to undesirable delays in providing advertisements or offerings.

### Publisher-Salted and Sub-Segmented Models

To address the above concerns, models may be publisher-salted and/or sub-segmented. In this regard, individual models may be generated for each Publisher with all identifiers salted with a constant, also referred to as a publisher identifier, for that Publisher (or individual applications, websites, etc.) in which matching will occur. By doing such, the Model Bucket Array (“MBA”—described further herein) and eligibility sequences may be unique to each Publisher (or applications, websites, etc.) thereby preventing either the MBA or eligibility sequences from acting as a fingerprint for a consumer. Models may also be broken down into chunks, where the chunk required by a device can be determined based on the identifiers available, again, salted by the publisher identifier and calculated modulo N where N is the number of chunks.

FIG. 4 shows a flow diagram 400 that outlines requesting advertisements and offers based on publisher-salted and sub-segmented models. Like user device 205, user device 405 may be controlled by a Publisher's application, website, or software during the steps outlined in FIG. 4. The user device 405 may request configuration details from the service server 401, which may be compared to service server 101 and 201. The request may include a publisher identifier that identifies the publisher that initiated the request. In instances where the Publisher's own system (e.g., publisher computing device 103) requests the configuration details directly from the service server 401, the publisher identifier may not be required.

In response to the request for configuration details, the service server 401 may return a “salt” and a “modulo” to the user device 405 (or the Publisher's own system when being used instead of a user device) as shown in block 412. As will be explained in more detailed herein, the “salt” and “modulo” are Publisher specific and guarantee that model evaluation “on-device” (e.g., on a user device) will be accurate and efficient. The “salt” is used to ensure that the model buckets for the same consumer on different Publishers will never be the same and so cannot be used to match consumers across Publishers.

Using the modulo and salt, the user device 405 may calculate a model bucket for each locally stored identifier, as shown in block 414. The model bucket calculation takes as input the configuration “salt”, the configuration “modulo”, and a stored consumer identifier. The model bucket calculation returns an integer for each stored identifier. Together, the model bucket calculations form a model bucket array (MBA) which indicates which models the device requires in order to calculate the campaign eligibility sequence. The model bucket calculation may be performed using software provided by the Server to the user device 405, such as within the Publisher's application or as a script, extension, applications, etc.

The user device 405 may request models for buckets included in the MBA from the service server 401, as shown in block 416. In this regard, the user device 405 may send to the service server 401 the MBA along with the request for relevant models.

In response to the request for relevant models, the service server 401 may return a number of pre-computed models to the user device 405, as shown in block 418. The pre-computed models that are returned to the user device may correspond with the MBA received in the request. The pre-computed models may be evaluated against the locally stored identifiers, as shown in block 420. The software for performing the model evaluation may be provided by the Service to the user device 401. The evaluation results in an eligibility sequence being generated. The eligibility sequence is essentially an “audience membership” list, which itself maps to Advertiser campaign eligibility sets. The eligibility sequence may be stored on the user device, as shown in block 422

The process for retrieving advertisements or offers based on the eligibility sequence produced using the process shown in FIG. 4, is the same as shown in FIG. 3. In this regard, the user device 405 may transmit the eligibility sequence for the consumer along with a request for an advertisement or offer to the service server 401. Without loss of generality and in order to obfuscate device network information, the request for the ad advertisement or offer (or collection of advertisements or offers) may be proxied through the Publisher server. In certain implementations, the service server may be specific to the Publisher instead of a centralized system. In this regard, some or all of the functions described herein as being performed by the Service on behalf of the Publisher may be performed by one or more service servers provisioned specifically for a particular Publisher and/or by one or more servers operated or otherwise controlled by the Publisher.

In response to the request, the service server may return one or more offers or advertisements to the user device 405. The one or more offers or advertisements provided to the user device 405 may be determined based on the eligibility of the consumer to view offers or advertisements as determined from the eligibility sequence and the models. The user device 405 may then display one or more of the returned advertisements or offers to the consumer

### Campaign Creation

As previously described, an Advertiser is a party, such as a business or marketing agency, which creates campaigns. The Advertiser may use software provided by the Service to create its campaigns. The Advertiser may define eligibility for the campaign by uploading a set of consumer identifiers (e.g. device id's, email addresses, etc.) to the Service. Eligibility to the campaign using the eligibility set can be based on inclusion (e.g., only consumer in the uploaded set are eligible for the campaign), exclusion (e.g., only consumer outside the uploaded set are eligible for the campaign), lookalike (e.g., network consumers that are similar to the uploaded set), or other eligibility criteria.

Without loss of generality, the Service may itself be considered an Advertiser. Further, in some cases the Service may define and/or modify the Eligibility Set for any campaign at the request of or on behalf of an Advertiser.

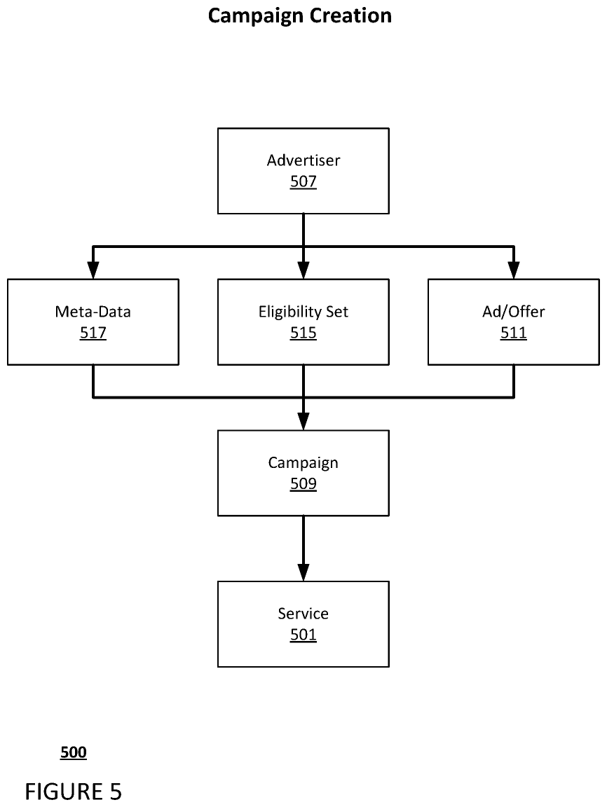

FIG. 5 illustrates the process of creating a campaign and uploading such to a Service (e.g., uploading to a service server, such as service server 101). An Advertiser 507 may use software provided by the Service to create an advertisement or offer campaign 509, which may include the advertisements and offers 511, an eligibility set 515, and meta-data 517 associated with the advertisement or offer campaign. Meta-data may include ad creatives (e.g., text, images, colors, etc.) campaign timelines (e.g., start and end dates) exposure rules (e.g., max ad views) campaign budget, and other such data, rules, or exemptions that could apply to a campaign. The generated campaign may be uploaded by the Advertiser 507 to the Service 501.

### Model Generation

The models discussed herein provide mathematical representations for set memberships. To be a valid model, the model should satisfy most, if not all of the following criteria:

With probability approaching 1, if an element is part of the set, the model will return that the element is part of the set;

With probability approaching 1, if an element is not part of the set, the model will return that the element is not part of the set;

Evaluation of the model should be efficient (e.g., require relatively little computation);

The storage space requirement of the model should be extremely low compared to the size of the set;

The exact elements that comprise the set cannot be reconstructed by an outside party; and

If the model is evaluated within two separate environments (e.g., elements information is not shared between environments) and the model returns the same output for both environments, this does not imply that the element used to evaluate the model was the same in both cases.

There are a number of possible techniques that can be used to generate models that satisfy such criteria. Without loss of generality, in the following sections the Bloom Filter and its variants, such as the Bloomier Filter, are discussed, although it will be understood that other techniques may be used. Moreover, the data structures described herein, such as the eligibility sequence and models are described with regard to particular implementations, it will be understood that other such data structures may be used without requiring alternation to the processes and techniques described herein.

For model generation, consider that multiple advertisers have each created and deployed multiple campaigns, and that each campaign represents an offer and/or advertisement that has eligibility requirements defined according to a set of consumer identifiers. In other words, each campaign includes an associated eligibility set as explained with regard to FIG. 5.

The Service, after being provided with the campaign creates a model, such as by using a cascade of Bloom Filters, that map an array of consumer identifiers, all assumed to come from a single consumer, to an eligibility sequence (e.g., 0's and 1's, or some other numerical, alphabetical, or alphanumerical sequence) which the Service is able to interpret with respect to campaign eligibility for the consumer. For example, each 0 and 1 may map to a specific campaign with 0 denoting that the consumer is not eligible and 1 denoting that the consumer is eligible.

An eligibility sequence represents a consumer's eligibility to different campaigns. An eligibility sequence is “reachable” if there exists at least one consumer that maps to that sequence. For example, consider the sequence “00110”. This sequence—“00110”—is reachable if there exists at least one consumer that maps to that sequence. Not all sequences are guaranteed to be reachable.

In some instances, the model may introduce privacy preserving “noise” into the model output. For instance, when generating the model the Service may introduce “noise” such that every reachable eligibility sequence has greater than or equal to D>1 consumer identifiers associated with it, where D is the minimum number of consumers matching to any reachable eligibility sequence, thus ensuring that the model output alone cannot be used to identify a consumer across different Publisher entities, such as applications and websites.

The “noise” described herein may alter the model without much reduction of accuracy, so that if there is one person who maps to an eligibility sequence, e.g. “00110”, then there exists at least D−1 other people who also map to that eligibility sequence. For example, consider D=2: If eligibility sequence “0011” has 0 matching consumers, no further action may be required. However, if eligibility sequence “0010” has 1 matching consumer, noise may be introduced to either move that consumer out of “0010” or it will move another consumer into “0010”—either addition of “noise” would suffice. Hence, if the eligibility sequence “00110” is received from publisher A and eligibility sequence “00110” from publisher B, there is no guarantee that the eligibility sequences from Publishers A and B, while the same, are assigned to the same consumer. Accordingly, eligibility sequences from across Publishers cannot be a fingerprint for consumers. Further, the size of the model may be increased or decreased based on a required or requested accuracy of campaign targeting performance.

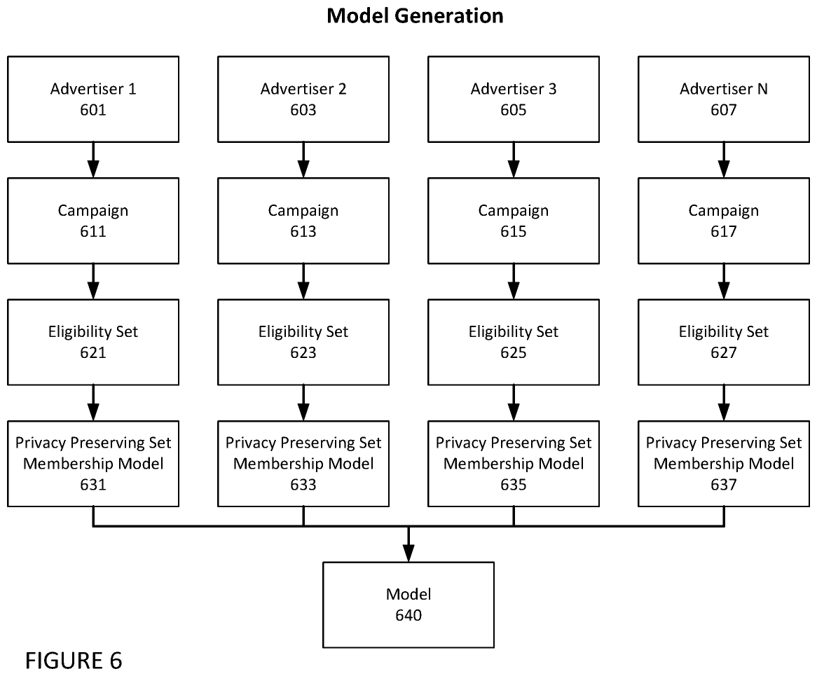

FIG. 6 illustrates an example illustration of model generation based multiple advertising campaigns. Advertisers 1-N (601-607) may upload campaigns 611-617 and eligibility sets associated with those campaigns 621-627, may be generated, such as by the Service. Noise may be added to each eligibility set to preserve privacy of the consumers and privacy preserving set membership models 631-637 may be generated. An overall model 640 may then be generated using the privacy preserving set membership models 631-637.

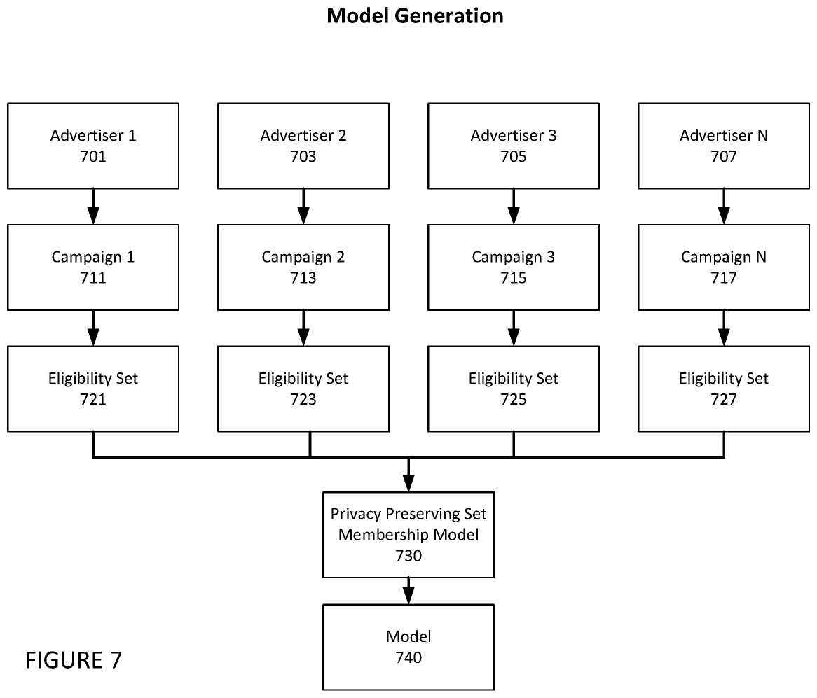

To improve model compression, the same privacy preserving “noise” may be added to all campaigns as illustrated in FIG. 7. In this regard, Advertisers 1-N (701-707) may upload campaigns 711-717 and eligibility sets associated with those campaigns 721-727, may be generated, such as by the Service. Noise may be added to all eligibility sets to preserve privacy of the consumers and a privacy preserving set membership model 730 may be generated. An overall model 740 may then be generated using the privacy preserving set membership model 730

Once constructed, the model may be sent from the Service to the Publisher. Although the models may be provided to the Publishers, the model preserves the privacy of the consumer by obfuscating the consumer identifiers that were used to create the campaign targeting eligibility rules.

### Low Bandwidth Model Generation

The models generated with regard to FIGS. 5 and 6, when deployed, should have space characteristics that are acceptable for server to server integrations between the Publisher and the Service, referred to herein as “on premises” integrations. However, in low bandwidth situations the number of campaigns and the size of the eligibility sets may result in a single model that is prohibitive for use by many user devices, referred to herein as “on device”.

To address this issue, a pre-processing step for creating sub-models may be used. Typically, the pre-processing step would be used in a scenario where (i) the user device, such as user device 105, is requesting a model in low bandwidth on behalf of a single consumer; and (ii) the consumer identifiers (e.g. device id's, email addresses, etc.) are locally stored on the user device. In this scenario, the process outlined herein preserves all vital characteristics of the full model with respect to consumer privacy and model accuracy while reducing the amount of bandwidth and processing required by the user device.

To control the size of the models and/or sub-models returned to the client, the pre-processing step may use private consumer identifiers from the eligibility set provided by the Advertiser to create separate campaigns from the larger campaign provided by the Advertiser. These separate campaigns may then be modeled individually, thereby creating sub-models.

More specifically, for every campaign that has a set of consumer identifiers associated with it defining eligibility (e.g., an eligibility set) N separate campaigns may be created. Each of the N campaigns may have a set eligibility defined by a set of consumer identifiers that is approximately 1/N the size of the original campaign. The set of consumer identifiers that comprise each campaign “Cᵢ” is deterministic and is constructed according to the following steps:

The consumer identifier may cleaned, such as by converting it to all lower case, and processed through a stable one-way hash function, such as sha256—In some instances, a stable, Publisher-specific “salt” may be added to the stable one-way hash function;

The resulting string, generated from processing the cleaned consumer identifier through the one-way hash function, is then transformed into an integer, such as a Big Integer;

The Big Integer may then be processed through a Modulo operation;

The resulting integer of processing the Big Integer through the Modulo operation, i∈{0, 1, . . . , N}, may be used to define which campaign the identifier is added. For instance, if a consumer identifier maps to 34, then the campaign it is associated with is C34.

Applying this pre-processing step to every campaign, the following may be provided: (i) By controlling N, the expected size of the sub-model Mᵢ that needs to be sent to the requesting user device (or server) may be increased or decreased, thereby increasing or decreasing the amount of bandwidth required to send the sub-model Mᵢ; (ii) Every Sub-Model Mᵢ inherits the privacy and accuracy characteristics the Model M; and (iii) For any consumer identifier I that maps to i according to the method outlined above, with probability approaching 1 the output of the sub-model Mᵢ will equal the output of the Model M.

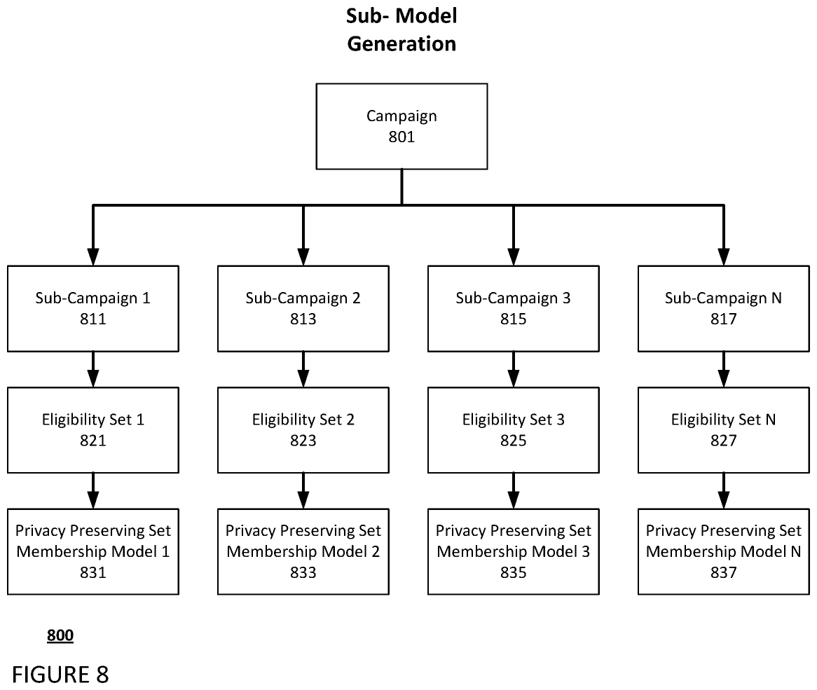

FIG. 8 illustrates an example illustration of sub-model generation based on a single advertising campaign. An Advertiser (not shown) may upload a campaign 801. The campaign may be split into sub-campaigns 811-817 based on the number of consumers being targeted by the campaign. For each sub-campaign 811-817, an eligibility set 821-827 may be generated and noise may be added to generate privacy preserving set membership models 831-837.

If the Publisher opts to apply the stable Publisher-specific “salt” to the identifier during pre-processing, then the Sub-Models will become Publisher specific and as a result, the Service must store a unique set of Sub-Models for every Publisher that requests this. Under this optional extension, privacy protection for the Publisher's consumers is strengthened.

It should be noted that the above pre-processing step that creates sub-models, including hashing and model separation, are only one of many potential pre-processing mechanisms for deploying privacy preserving models at scale in low bandwidth situations. Other pre-processing mechanisms may also be used and may be implemented using different information, such as location information being used for model separation. In another example, different hashing mechanisms than SHA256, may be replaced by SHA1 hashing or some other such hashing mechanism.

### Model Request and Evaluation

The Publisher may request, such as through software provided by the Service, an up-to-date model from the Service. The Service may evaluate the request and return a model. For each consumer, the Publisher may evaluate the returned model using the list of private consumer identifiers representative of that consumer. Although, the Publisher may evaluate the returned model for all consumers, the Publisher may evaluate any number of consumers. At the end of the evaluation, the Publisher may receive an eligibility sequence or other such output representing campaign eligibility for said consumer.

### Low Bandwidth Model Request and Evaluation

In low bandwidth situations, such as where (i) the user device, such as user device 105, is requesting a model in low bandwidth on behalf of a single consumer; and (ii) the consumer identifiers (e.g. device id's, email addresses, etc.) are locally stored on the user device, the user device may construct a MBA. The MBA may be constructed using software provided by the Service. The MBA is an array of opaque, non-unique, non-consumer-identifying integers designed to communicate to the Service which Sub-Models to return for evaluation.

The MBA is constructed using the same deterministic logic used by the Service for sub-model construction and as outlined in the section titled “Low Bandwidth Model Generation”. In this regard, for each consumer identifier locally stored on the user device,
The consumer identifier may cleaned, such as by converting it to all lower case, and processed through a stable one-way hash function, such as sha256;
   In some instances, a stable, Publisher-specific “salt” may be added to the stable one-way hash function;
The resulting string, generated from processing the cleaned consumer identifier through the one-way hash function, is then transformed into an integer, such as a Big Integer;
The Big Integer may then be processed through a Modulo operation;
The resulting integer i∈{0, 1, . . . , N} is then added to the MBA.

Processing the consumer identifier through the has function and the addition of a Publisher-specific “salt” may occur on the user device or on the Publisher's system, such as publisher computing device 103. By hashing and salting on the Publisher's system, the Publisher salt may remain unknown to the user device.

The constructed MBA is an array of integers that when communicated to the Service provides an indication to the Service that sub-models associated with those integers should be returned. For instance, the MBA provided to the Service may include an array, such as [1, 45, 4363]. In response to receiving the array, the Service may return sub-models M₁, M₄₅, and M₄₃₆₃.

In some instances, noise may be added to the MBA without any loss of accuracy. In this regard, one or more random integers may be added to the MBA, such as by the software provided by the Service to the Publisher. In this regard, the Service may return models for all integers in the MBA, including the random integers. The publisher (or the publisher operating service software) would ignore the model returned associated with the random integer.

Additionally, and as described above, the Publisher may request that the Service add a stable Publisher-specific “salt” to the stable one-way hash such that when the stable Publisher-specific salt is added to the cleaned consumer identifier, the MBA sequence for the consumer becomes unique to just that Publisher. In this regard, the Service and Publisher may agree on a stable shared salt, and that stable, shared salt may be what the Service and the Publisher use for the hashing during MBA creation, model creation, and/or model evaluation. By doing such, the possibility that the Service, or any other party, may use the MBA as a consumer fingerprint which strengthens the privacy of the consumer, while at the same time enabling the Service to construct, store, and serve Publisher-specific models.

After receipt of the models, the user device, using software provided by the Service or some other software, may evaluate the stored consumer identifiers against the models resulting in a collection of eligibility sequences. The client, using software provided by the Service or otherwise, will then aggregate the eligibility sequences into a single eligibility sequence.

### Personalized Ad/Offer Request

For each consumer where the Publisher has evaluated the consumer identifiers against the model and received an eligibility sequence, the Publisher may request a campaign or a set of campaigns from the Service. In the request, the Publisher may send the eligibility sequence to the Service in the request.

The Publisher may request a complete and up-to-date campaign model from the Service. By requesting the complete and up-to-date campaign model, the Publisher may run software provided by the Service or otherwise, in order to identify the campaign or set of campaigns to show to the consumer. By doing such, the eligibility sequence is never sent to the Service further increasing consumer privacy. In some instances, the complete and up-to-date model may be provided by the Service to the Publisher in a compressed form.

### Model Deployment Validation

Creating and deploying privacy preserving models may require trust across the actors in the process, including the Publisher, Advertiser, and Service. In this regard, the Advertiser relies on the Service to accurately model their campaigns, the Advertiser and the Service rely on the Publisher to accurately represent their consumer identifiers and not manipulate the system to garner better offers, and the Publisher relies on the Advertiser and/or the Service to measure value generation of the campaign, such as through a trusted vendor, without access to Publisher private consumer identifiers.

To increase the trust between the actors, there are various technical mechanisms that can be deployed in order to measure and detect anomalies in behavior by the actors. One such mechanism includes, during the creation of a model for a Publisher, the Service constructs a probability an expected/anticipated distribution over the eligibility sequences. After deployment, the Service, using the results of consumer activity on the Publisher, may construct a sampled distribution over the observed eligibility sequences. The Service may use the sampled distribution to detect anomalies, such as by using mathematical methods for measuring statistical divergence, by comparing the expected distribution over the eligibility sequences to the sampled distribution over the observed eligibility sequences. In the event divergences becomes larger than a threshold value, which may be defined by the Service or other actor, alerts may be generated to one or more of the actors so that steps may be taken to further investigate and, if necessary, remedy the cause of the divergence. Additionally, market dynamics and familiarity may increase trust in the processes and systems described herein.

### Extensions

Privacy preserving consumer behavior classifier created via on-device consumer behavior signals;
Campaign matching via eligibility sequence (offer/ad eligibility) and behavior classifier (offer/ad affinity ranking);
A Federated Approach to constructing privacy preserving behavioral sets for ad personalization (including the creation of lookalike sets) via an on device consumer behavior classifier

As outlined above, the Service constructs models within the server environment from data being shared from an Advertiser. The above extensions relate to a behavior driven model being constructed “on device.” In this regard, a Publisher requesting a model may update the model on-device without the need for data to be sent to the server.

For privacy preserving consumer behavior classifier created via on-device consumer behavior signals—Assume that data about consumer behavior on device may be mapped to a consumer behavior classification sequence, which can be a numerical value, such as 1's and 0's. The Service may then update a model on device that maps the consumer identifiers to the behavior classification sequence.

For campaign matching via eligibility sequence (offer/ad eligibility) and behavior classifier (offer/ad affinity ranking)—Campaign matching may be based on both the eligibility sequence returned as well as the behavior classification sequence. For example, a campaign is structured in a way such that:

Eligibility is based on consumer identifiers only;

Eligibility is based on consumer identifier and behavior classification; or

Eligibility is based only on behavior classification.

For a federated approach to constructing privacy preserving behavioral sets for ad personalization (including the creation of lookalike sets) via an on device consumer behavior classifier—Target sets based on behavior may be constructed using on device model updates, so that consumer identifiers and behavior data is never sent off device. Lookalike audiences that are similar to eligibility sets uploaded by the advertisers may be created for the advertisers.

1. A method for targeting advertisements and offers to consumers:
receiving, by one or more processors, a set of campaigns, each campaign in the set of campaigns including an eligibility set defined by a set of consumer identifiers;
converting, by the one or more processors, the eligibility set of each campaign into a privacy preserving model that maps the set of consumer identifiers to any number of advertisements or offers in the set of campaigns; and
providing, by the one or more processors, the privacy preserving model to a publisher.

2. The method of claim 1, wherein each campaign in the set of campaigns includes at least one advertisement or offer.

3. The method of claim 1, wherein the converting eligibility set further includes mapping the set of consumer identifiers to an eligibility sequence representing each consumers to each of the campaigns in the set of campaigns.

4. The method of claim 3, wherein the eligibility sequence includes a listing of numerical, alphabetical, or alphanumerical values, wherein each value indicates a respective consumers eligibility for a particular campaign in the set of campaigns.

5. The method of claim 1, further comprising:
prior to converting the eligibility set of each campaign into a privacy preserving model, adding noise into the eligibility set of each campaign.

6. The method of claim 1, further comprising:
prior to converting the eligibility set of each campaign into a privacy preserving model, adding noise into the eligibility set of each campaign, wherein the noise added to each of the eligibility sets is the same.

7. The method of claim 1, wherein mapping the set of consumer identifiers to any number of advertisements or offers in the set of campaigns includes processing the set of consumer identifiers through one or more Bloom filters and/or Bloomer filters.

8. A system for targeting advertisements and offers to consumers, the system comprising:
one or more processors; and
memory storing instructions, the instructions, when executed by the one or more processors, cause the one or more processors to:
receive a set of campaigns, each campaign in the set of campaigns including an eligibility set defined by a set of consumer identifiers;
convert the eligibility set of each campaign into a privacy preserving model that maps the set of consumer identifiers to any number of advertisements or offers in the set of campaigns; and
provide the privacy preserving model to a publisher.

9. The system of claim 8, wherein each campaign in the set of campaigns includes at least one advertisement or offer.

10. The system of claim 8, wherein the converting eligibility set further includes mapping the set of consumer identifiers to an eligibility sequence representing each consumers to each of the campaigns in the set of campaigns.

11. The system of claim 10, wherein the eligibility sequence includes a listing of numerical, alphabetical, or alphanumerical values, wherein each value indicates a respective consumers eligibility for a particular campaign in the set of campaigns.

12. The system of claim 8, wherein the instructions further cause the one or more processors to:
prior to converting the eligibility set of each campaign into a privacy preserving model, adding noise into the eligibility set of each campaign.

13. The system of claim 8, wherein the instructions further cause the one or more processors to:
prior to converting the eligibility set of each campaign into a privacy preserving model, adding noise into the eligibility set of each campaign, wherein the noise added to each of the eligibility sets is the same.

14. The system of claim 8, wherein mapping the set of consumer identifiers to any number of advertisements or offers in the set of campaigns includes processing the set of consumer identifiers through one or more Bloom filters and/or Bloomer filters.

15. A non-transitory computer-readable medium storing instructions, the instructions, when executed by one or more processors, causing the one or more processors to:
receive a set of campaigns, each campaign in the set of campaigns including an eligibility set defined by a set of consumer identifiers;
convert the eligibility set of each campaign into a privacy preserving model that maps the set of consumer identifiers to any number of advertisements or offers in the set of campaigns; and
provide the privacy preserving model to a publisher.

16. The non-transitory computer-readable medium of claim 15, wherein each campaign in the set of campaigns includes at least one advertisement or offer.

17. The non-transitory computer-readable medium of claim 15, wherein the converting eligibility set further includes mapping the set of consumer identifiers to an eligibility sequence representing each consumers to each of the campaigns in the set of campaigns.

18. The non-transitory computer-readable medium of claim 17, wherein the eligibility sequence includes a listing of numerical, alphabetical, or alphanumerical values, wherein each value indicates a respective consumers eligibility for a particular campaign in the set of campaigns.

19. The non-transitory computer-readable medium of claim 15, wherein the instructions further cause the one or more processors to:
prior to converting the eligibility set of each campaign into a privacy preserving model, adding noise into the eligibility set of each campaign.

20. The non-transitory computer-readable medium of claim 15, wherein the instructions further cause the one or more processors to:
prior to converting the eligibility set of each campaign into a privacy preserving model, adding noise into the eligibility set of each campaign, wherein the noise added to each of the eligibility sets is the same.
